(19) United States
(12) Patent Application Publication
(10) Pub. No.: US 2024/0260124 A1
(43) Pub. Date: Aug. 1, 2024

(54) COMMUNICATION METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/633,970

(22) Filed: Apr. 12, 2024

Related U.S. Application Data
(63) Continuation of application No. PCT/JP2022/038110, filed on Oct. 12, 2022.
(60) Provisional application No. 63/255,579, filed on Oct. 14, 2021.

(51) Int. Cl. H04W 76/27; H04W 76/40

(52) U.S. Cl. CPC H04W 76/27; H04W 76/40

(57) ABSTRACT

In a first aspect, a communication method is a communication method performed by a user equipment in a mobile communication system that provides a multicast and broadcast service (MBS) and includes receiving MBS data from a base station via a multicast radio bearer (MRB), receiving, from the base station, a radio resource control (RRC) reconfiguration message indicating a bearer type change of the MRB, triggering transmission of a PDCP status report indicating a data reception status in a PDCP entity associated with the MRB in response to the bearer type change indicated by the RRC reconfiguration message being a change to an Acknowledged Mode (AM) MRB type, and transmitting the PDCP status report to the base station.

### RELATED APPLICATIONS

The present application is a continuation based on PCT Application No. PCT/JP2022/038110, filed on Oct. 12, 2022, which claims the benefit of U.S. Provisional Patent Application No. 63/255,579 filed on Oct. 14, 2021. The content of which is incorporated by reference herein in their entirety.

### TECHNICAL FIELD

The present disclosure relates to a communication method used in a mobile communication system.

### BACKGROUND OF INVENTION

In 3rd Generation Partnership Project (3GPP) standards, technical specifications of New Radio (NR) being radio access technology of the fifth generation (5G) have been defined. NR has features such as high speed, large capacity, high reliability, and low latency, in comparison to Long Term Evolution (LTE) being radio access technology of the fourth generation (4G). In 3GPP, there have been discussions for establishing technical specifications of multicast and broadcast services (MBS) of 5G/NR (for example, see Non-Patent Document 1).

### CITATION LIST

### Non-Patent Literature

Non-Patent Document 1: 3GPP Contribution: RP-201038, “WID revision: NR Multicast and Broadcast Services”

### SUMMARY

5G/NR multicast and broadcast services are desired to provide enhanced services compared to 4G/LTE multicast and broadcast services.

In view of this, the present disclosure provides a communication method and a user equipment for enabling implementation of enhanced multicast and broadcast services.

In a first aspect, a communication method is a communication method performed by a user equipment in a mobile communication system that provides a multicast and broadcast service (MBS) and includes receiving MBS data from a base station via a multicast radio bearer (MRB), receiving, from the base station, a radio resource control (RRC) reconfiguration message indicating a bearer type change of the MRB, triggering transmission of a PDCP status report indicating a data reception status in a PDCP entity associated with the MRB in response to the bearer type change indicated by the RRC reconfiguration message being a change to an Acknowledged Mode (AM) MRB type, and transmitting the PDCP status report to the base station.

In a second aspect, a communication method is a communication method performed by a user equipment in a mobile communication system that provides a multicast and broadcast service (MBS) and includes receiving MBS data from a base station via a multicast radio bearer (MRB), autonomously triggering transmission of a PDCP status report indicating a data reception status in a PDCP entity associated with the MRB in response to transition from an RRC idle state or an RRC inactive state to an RRC connected state and/or occurrence of discard of an MBS data packet in an RLC layer, and transmitting the PDCP status report to the base station.

In a third aspect, a communication method is a communication method performed by a base station in a mobile communication system that provides a multicast and broadcast service (MBS) and includes transmitting MBS data to a user equipment via a multicast radio bearer (MRB), transmitting, to the user equipment, an RRC reconfiguration message that is a message indicating a bearer type change of the MRB, the RRC reconfiguration message including a first information element indicating re-establishment of a PDCP entity associated with the MRB, and receiving a PDCP status report transmitted from the user equipment based on the first information element. The transmitting the RRC reconfiguration message includes transmitting the RRC reconfiguration message further including a second information element indicating maintaining a state of a header compression protocol in the PDCP entity when the RRC reconfiguration message includes the first information element.

In a fourth aspect, a user equipment is a user equipment used in a mobile communication system that provides a multicast and broadcast service (MBS) and includes a receiver that receives MBS data from a base station via a multicast radio bearer (MRB) and receives, from the base station, a radio resource control (RRC) reconfiguration message indicating a bearer type change of the MRB, a controller that triggers transmission of a PDCP status report indicating a data reception status in a PDCP entity associated with the MRB in response to the bearer type change indicated by the RRC reconfiguration message being a change to an Acknowledged Mode (AM) MRB type, and a transmitter that transmits the PDCP status report to the base station.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signalling (control signal).

FIG. 6 is a diagram illustrating an overview of MBS traffic delivery according to an embodiment.

FIG. 7 is a diagram illustrating delivery modes according to an embodiment.

FIG. 8 is a diagram illustrating an example of internal processing related to MBS reception of a UE 100 according to an embodiment.

FIG. 9 is a diagram illustrating another example of the internal processing related to the MBS reception of the UE 100 according to an embodiment.

FIG. 10 is a diagram illustrating operations of a PDCP layer in the mobile communication system according to an embodiment.

FIG. 11 is a diagram illustrating an example of PDCP state variables according to an embodiment.

FIG. 12 is a diagram illustrating an example of a PDCP data PDU constituting MBS data according to an embodiment.

FIG. 13 is a diagram illustrating operations for identifying RCVD_COUNT that is a COUNT value of the PDCP data PDU received in a receiving PDCP entity of the UE according to an embodiment.

FIG. 14 is a diagram illustrating operations of the receiving PDCP entity of the UE related to a PDCP status report according to an embodiment.

FIG. 15 is a diagram illustrating operations of an RRC entity of the UE related to the PDCP status report according to an embodiment.

FIG. 16 is a diagram illustrating a configuration example of the PDCP status report according to an embodiment.

FIG. 17 is a diagram illustrating operations of a UE according to a first embodiment.

FIG. 18 is a diagram illustrating operations of a receiving PDCP entity of a UE according to a first example of the first embodiment.

FIG. 19 is a diagram illustrating operations of a receiving PDCP entity of a UE according to a second example of the first embodiment.

FIG. 20 is a diagram illustrating operations of a receiving PDCP entity of a UE according to a third example of the first embodiment.

FIG. 21 is a diagram illustrating operations of a UE according to a second embodiment.

FIG. 22 is a diagram illustrating operations of a mobile communication system according to a third embodiment.

### DESCRIPTION OF EMBODIMENTS

A mobile communication system according to an embodiment is described with reference to the drawings. In the description of the drawings, the same or similar parts are denoted by the same or similar reference signs.

### First Embodiment

### Configuration of Mobile Communication System

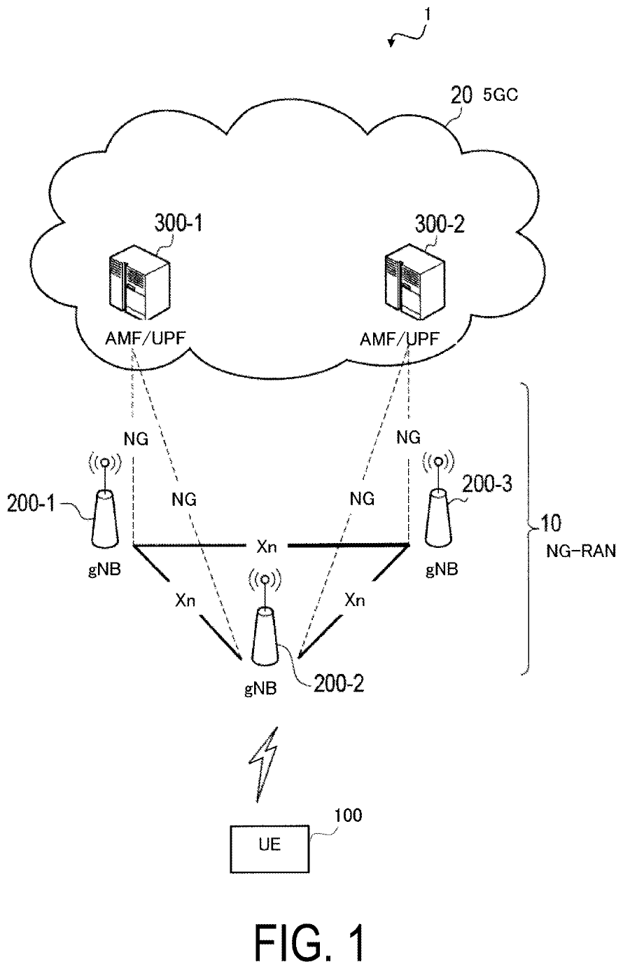

FIG. 1 is a diagram illustrating a configuration of a mobile communication system according to a first embodiment. The mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signalling. The UPF controls data transfer. The AMF and UPF are connected to the gNB 200 via an NG interface which is an interface between a base station and the core network.

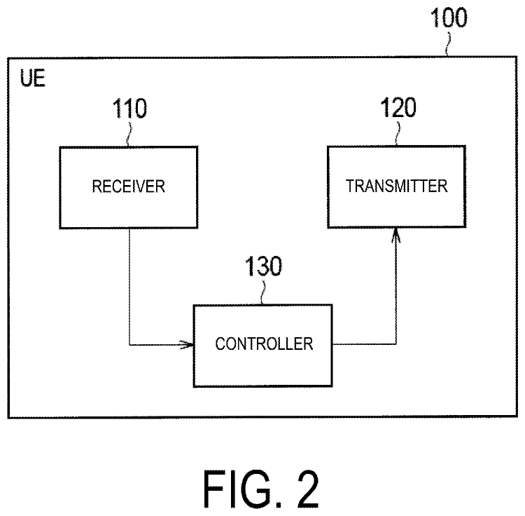

FIG. 2 is a diagram illustrating a configuration of the UE 100 (user equipment) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processes in the UE 100. Such processes include processes of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

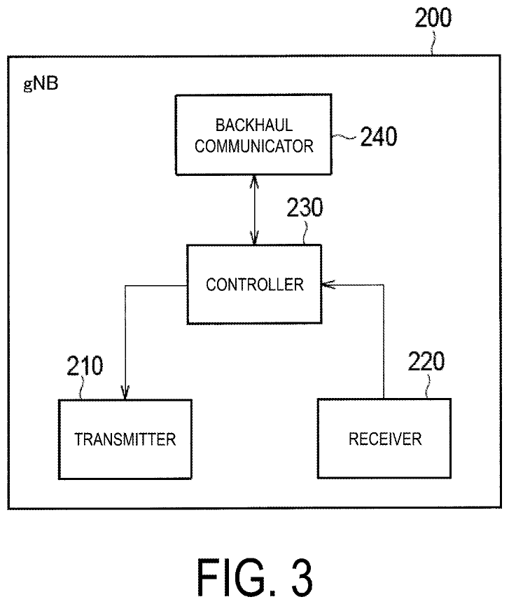

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processes in the gNB 200. Such processes include processes of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface between base stations. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

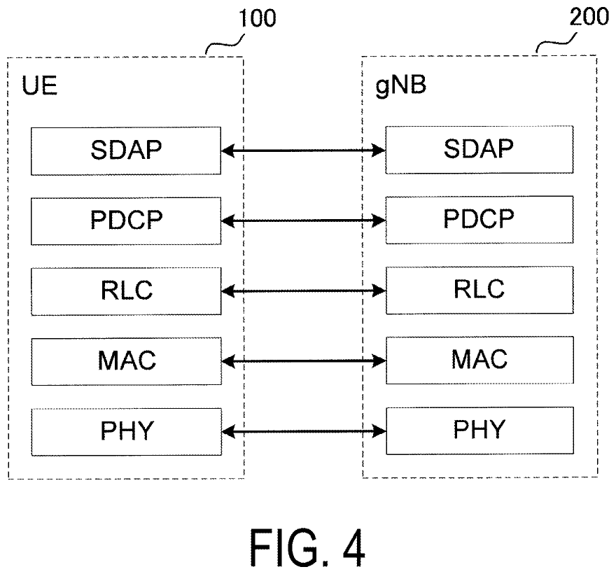

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

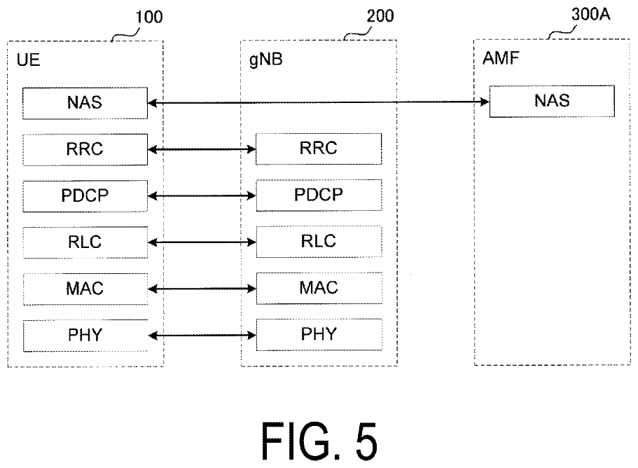

FIG. 5 is a diagram illustrating a configuration of a protocol stack of a radio interface of a control plane handling signalling (a control signal).

The protocol stack of the radio interface of the control plane includes a Radio Resource Control (RRC) layer and a Non-Access Stratum (NAS) layer instead of the SDAP layer illustrated in FIG. 4.

RRC signalling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signalling is transmitted between the NAS layer of the UE 100 and the NAS layer of an AMF 300A. Note that the UE 100 includes an application layer other than the protocol of the radio interface. A layer lower than the NAS layer is referred to as an AS layer.

### Overview of MBS

An overview of the MBS according to the first embodiment is described. The MBS is a service in which the NG-RAN 10 can provide broadcast or multicast, i.e., Point To Multipoint (PTM) data transmission to the UE 100. Assumed use cases (service types) of the MBS include public safety communication, mission critical communication, Vehicle to Everything (V2X) communication, IPv4 or IPv6 multicast delivery, Internet protocol television (IPTV), group communication, and software delivery.

A broadcast service provides a service to every UE 100 within a particular service area for an application not requiring highly reliable QoS. An MBS session used for the broadcast service is referred to as a broadcast session.

A multicast service provides a service not to every UE 100, but to a group of UEs 100 joining the multicast service (multicast session). An MBS session used for the multicast service is referred to as a multicast session. The multicast service can provide the same content to the group of UEs 100 through a method with higher radio efficiency than the broadcast service.

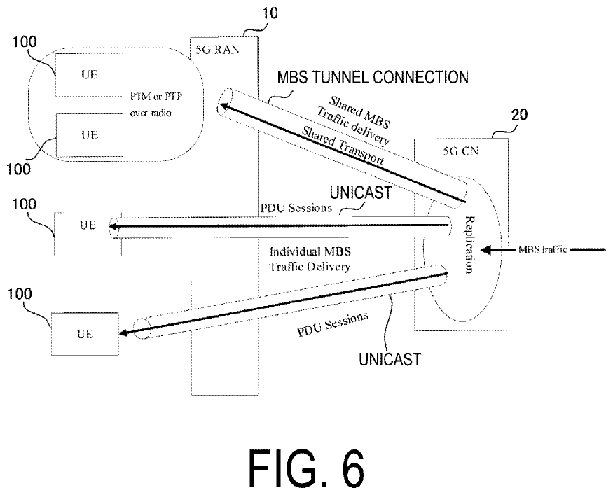

FIG. 6 is a diagram illustrating an overview of MBS traffic delivery according to the first embodiment.

MBS traffic (MBS data) is delivered from a single data source (application service provider) to a plurality of UEs. The 5G CN (5GC) 20, which is a 5G core network, receives the MBS data from the application service provider and performs Replication of the MBS data to deliver the resultant.

From the perspective of the 5GC 20, two multicast delivery methods are possible: 5GC Shared MBS Traffic delivery and 5GC Individual MBS Traffic delivery.

In the 5GC individual MBS traffic delivery method, the 5GC 20 receives a single copy of MBS data packets and delivers individual copies of these MBS data packets to the individual UEs 100 via PDU sessions of the individual UEs 100. Thus, one PDU session for each UE 100 needs to be associated with a multicast session.

In the 5GC shared MBS traffic delivery method, the 5GC 20 receives a single copy of MBS data packets and delivers the single copy of the MBS packets to a RAN node (i.e., the gNB 200). The gNB 200 receives the MBS data packets via MBS tunnel connection, and delivers those to one or more UEs 100.

From the perspective of the RAN (5G RAN) 10, two delivery methods are possible for radio transmission of the MBS data in the 5GC shared MBS traffic delivery method: a Point-to-Point (PTP) delivery method and a Point-to-Multipoint (PTM) delivery method. PTP means unicast, and PTM means multicast and broadcast.

In the PTP delivery method, the gNB 200 wirelessly delivers the individual copies of the MBS data packets to the individual UEs 100. On the other hand, in the PTM delivery method, the gNB 200 wirelessly delivers the single copy of the MBS data packets to a group of the UEs 100. The gNB 200 can dynamically determine whether to use the PTM or PTP delivery method as a method for delivering the MBS data to one UE 100.

The PTP and PTM delivery methods are mainly related to the user plane. Modes for controlling the MBS data delivery include two delivery modes: a first delivery mode and a second delivery mode.

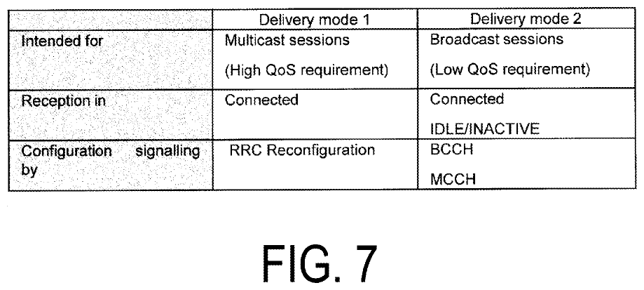

FIG. 7 is a diagram illustrating the delivery modes according to the first embodiment.

The first delivery mode (Delivery mode 1 (DM1)) is a delivery mode that can be used by the UE 100 in the RRC connected state, and is a delivery mode for high QoS requirements. The first delivery mode is used for multicast sessions among MBS sessions. Note that the first delivery mode may be used for broadcast sessions. The first delivery mode may be available to the UE 100 in the RRC idle state or the RRC inactive state.

MBS reception configuration in the first delivery mode is performed through UE-dedicated signalling. For example, the MBS reception configuration in the first delivery mode is performed through an RRC Reconfiguration message (or an RRC Release message), which is an RRC message unicast from the gNB 200 to the UE 100.

The MBS reception configuration includes MBS traffic channel configuration information (hereinafter referred to as “MTCH configuration information”) about configuration of an MBS traffic channel transmitting MBS data. The MTCH configuration information includes MBS session information (including an MBS session identifier described below) relating to an MBS session and scheduling information of the MBS traffic channel corresponding to the MBS session. The scheduling information of an MBS traffic channel may include discontinuous reception (DRX) configuration of the MBS traffic channel. The discontinuous reception configuration may include at least one parameter of a timer value (On Duration Timer) for defining an on-period (On Duration: reception period), a timer value (Inactivity Timer) for extending the on-period, a scheduling interval or a DRX cycle (Scheduling Period, DRX Cycle), an offset value (Start Offset, DRX Cycle Offset) of a start subframe for scheduling or a DRX cycle, a start delay slot value (Slot Offset) of an on-period timer, a timer value (Retransmission Timer) for defining a maximum time until retransmission, and a timer value (HARQ RTT Timer) for defining a minimum interval until DL assignment of HARQ retransmission.

Note that the MBS traffic channel is a type of logical channel and may be referred to as an MTCH. The MBS traffic channel is mapped to a downlink shared channel (Down Link-Shared CHannel (DL-SCH)) being a type of transport channel.

The second delivery mode (Delivery mode 2 (DM2)) is a delivery mode that can be used not only by the UE 100 in the RRC connected state, but also by the UE 100 in the RRC idle state or the RRC inactive state, and is a delivery mode for low QoS requirements. The second delivery mode is used for broadcast sessions among MBS sessions. However, the second delivery mode may also be applicable to multicast sessions.

An MBS reception configuration in the second delivery mode is performed through broadcast signalling. For example, the MBS reception configuration in the second delivery mode is performed using a logical channel transmitted from the gNB 200 to the UE 100 through broadcast, for example, a broadcast control channel (BCCH) and/or a multicast control channel (MCCH). The UE 100 can receive the BCCH and the MCCH, using a dedicated RNTI defined in technical specifications in advance, for example. The RNTI for BCCH reception may be an SI-RNTI, and the RNTI for MCCH reception may be an MCCH-RNTI.

In the second delivery mode, the UE 100 may receive the MBS data in the following three procedures. First, the UE 100 receives MCCH configuration information on a SIB (MBS SIB) transmitted from the gNB 200 on the BCCH. Second, the UE 100 receives the MCCH from the gNB 200, based on the MCCH configuration information. On the MCCH, MTCH configuration information is transmitted. Third, the UE 100 receives the MTCH (MBS data), based on the MTCH configuration information. The MTCH configuration information and/or the MCCH configuration information may be hereinafter referred to as the MBS reception configuration.

In the first delivery mode and the second delivery mode, the UE 100 may receive the MTCH, using a group RNTI (G-RNTI) assigned from the gNB 200. The G-RNTI corresponds to an RNTI for MTCH reception. The G-RNTI may be included in the MBS reception configuration (MTCH configuration information).

The network can provide different MBS services for different MBS sessions. The MBS session is identified by at least one selected from the group consisting of a Temporary Mobile Group Identity (TMGI), a source-specific IP multicast address (which consists of a source unicast IP address, such as an application function and an application server, and an IP multicast address indicating a destination address), a session identifier, and a G-RNTI. At least one selected from the group consisting of the TMGI, the source specific IP multicast address, and the session identifier is referred to as an MBS session identifier. The TMGI, the source-specific IP multicast address, the session identifier, and the G-RNTI are collectively referred to as MBS session information.

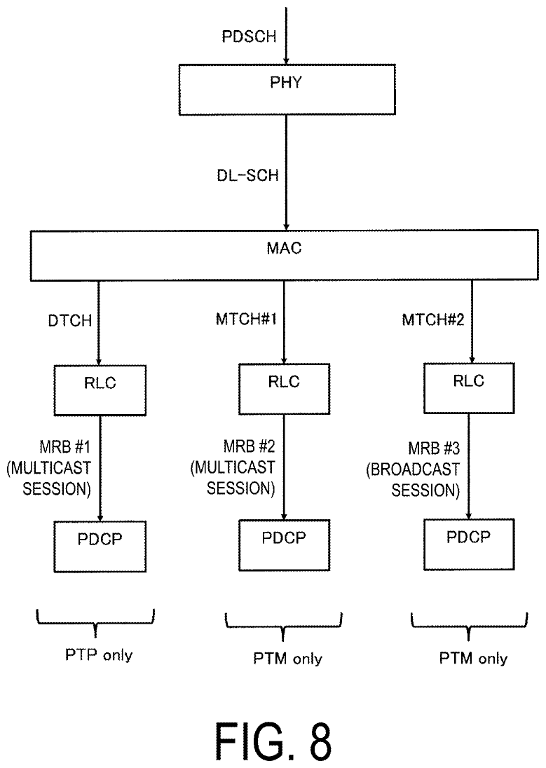

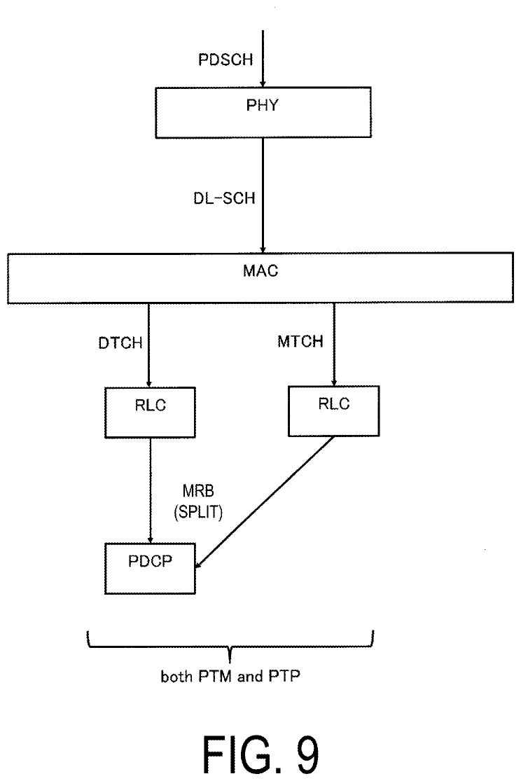

FIG. 8 is a diagram illustrating an example of internal processing related to the MBS reception of the UE 100 according to the first embodiment. FIG. 9 is a diagram illustrating another example of the internal processing related to the MBS reception of the UE 100 according to the first embodiment.

One MBS radio bearer (MRB) is one radio bearer transmitting a multicast session or a broadcast session. That is, a multicast session may be associated with an MRB or a broadcast session may be associated with an MRB.

The MRB and the corresponding logical channel (e.g., MTCH) are configured for the UE 100 from the gNB 200 through RRC signalling. An MRB configuration procedure may be separated from a data radio bearer (DRB) configuration procedure. In the RRC signalling, one MRB can be configured with “PTM only”, “PTP only”, or “both PTM and PTP”. Such a bearer type of the MRB may be changed by the RRC signalling.

FIG. 8 illustrates an example in which a multicast session and a dedicated traffic channel (DTCH) are associated with an MRB #1, a multicast session and an MTCH #1 are associated with an MRB #2, and a broadcast session and an MTCH #2 are associated with an MRB #3. That is, the MRB #1 is configured with PTP only MRB, the MRB #2 is configured with PTM only MRB, and the MRB #3 is configured with PTM only MRB. Note that the DTCH is scheduled using a cell RNTI (C-RNTI). The MTCH is scheduled using the G-RNTI.

The PHY layer of the UE 100 processes user data (received data) received on the PDSCH, which is one of physical channels, and routes the processed user data to the downlink shared channel (DL-SCH), which is one of transport channels. The MAC layer (MAC entity) of the UE 100 processes the data received on the DL-SCH and routes the received data to a corresponding logical channel (corresponding RLC entity) based on a logical channel identifier (LCID) included in the header (MAC header) included in the received data.

FIG. 9 illustrates an example in which the DTCH and the MTCH are associated with the MRB associated with the multicast session. Specifically, one MRB is split into two legs, one leg is associated with the DTCH, and the other leg is associated with the MTCH. The two legs are combined at the PDCP layer (PDCP entity). That is, the MRB is an MRB configured with both PTM and PTP. Such an MRB may be referred to as a split MRB.

### Overview of Operation of PDCP Layer

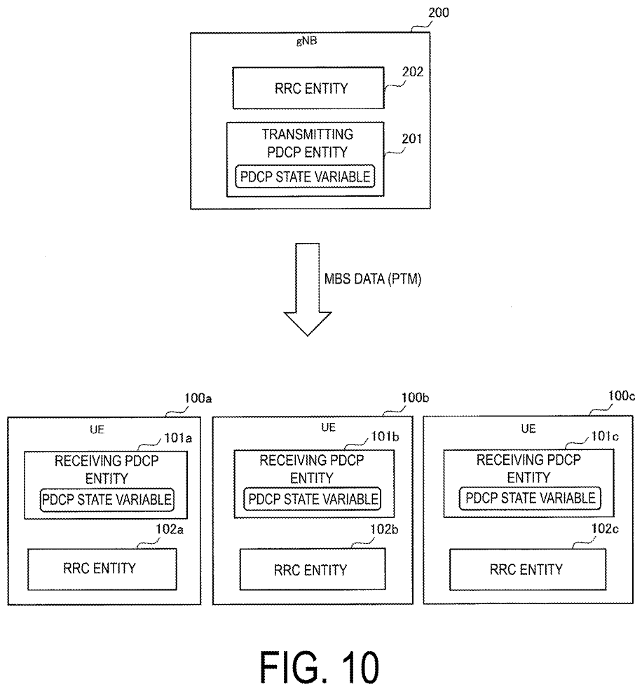

FIG. 10 is a diagram illustrating operations of the PDCP layer in the mobile communication system 1 according to the first embodiment.

The gNB 200 transmits MBS data of a certain MBS session to a plurality of UEs 100 (in the example of FIG. 10, a UE 100a to a UE 100c) via PTM (multicast or broadcast). The RRC state of each UE 100 may be any state (the RRC connected state, the RRC idle state, or the RRC inactive state). The MBS delivery mode may be the first delivery mode or the second delivery mode.

In the PDCP layer, the gNB 200 includes a transmitting PDCP entity 201 associated with the MBS session (specifically, a transmitting PDCP entity associated with a multicast radio bearer (MRB) belonging to the MBS session). The transmitting PDCP entity 201, when starting transmission of an MBS session, manages PDCP state variables updated in response to transmission of a PDCP data Protocol Data Unit (PDU) in the MBS session.

In the PDCP layer, each UE 100 includes a receiving PDCP entity 101 associated with the MBS session (specifically, a receiving PDCP entity associated with an MRB belonging to the MBS session). Each receiving PDCP entity 101 (in the example of FIG. 10, each of a receiving PDCP entity 101a to a receiving PDCP entity 101c), when starting reception of an MBS session, manages PDCP state variables updated in response to reception of a PDCP data PDU in the MBS session.

Note that the gNB 200 has an RRC entity 202 that transmits and receives RRC signalling to and from each UE 100. Each UE 100 has an RRC entity 102 (an RRC entity 102a to an RRC entity 102c) that transmits and receives RRC signalling to and from the gNB 200. The RRC entity 102 of the UE 100 controls the receiving PDCP entity 101 of the UE 100, based on the RRC signalling received from the RRC entity 202 of the gNB 200.

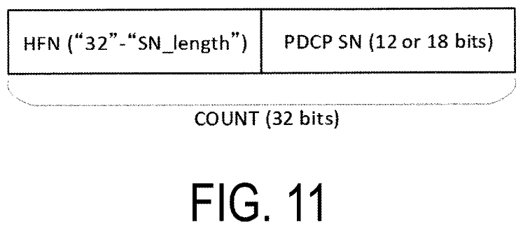

As illustrated in FIG. 11, the PDCP state variables may include a count value (COUNT value) consisting of a hyper frame number (HFN) that is counted up every time a PDCP sequence number makes one round and a PDCP sequence number (PDCP SN). For example, the COUNT value has a bit length of 32 bits, the PDCP SN has a bit length (SN_length) of 12 bits or 18 bits, and the HFN has a bit length obtained by subtracting the bit length of the PDCP SN from the bit length of the COUNT value. The bit length of the PDCP SN may be configured using RRC signalling. The bit length of the PDCP SN may be a default value (a fixed value that is determined in advance). Note that the term “PDCP state variable” need not necessarily indicate the COUNT value, and may also be used as a term indicating various variables (such as the HFN, the PDCP SN, or the TX_NEXT, the RX_NEXT, the RX_DELIV, and the RX_REORD) handled in the PDCP layer.

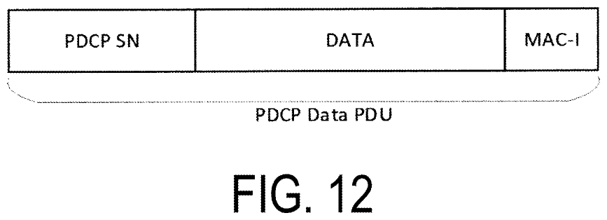

FIG. 12 is a diagram illustrating an example of the PDCP data PDU constituting MBS data. As illustrated in FIG. 12, the PDCP data PDU includes a PDCP SN, data, and a MAC-I. The PDCP SN is a sequence number sequentially assigned to the PDCP data PDU. The data corresponds to a PDCP Service Data Unit (SDU). The MAC-I corresponds to a message authentication code. The PDCP data PDU may not include the MAC-I. As described above, the PDCP data PDU includes the PDCP SN but does not include the HFN. Thus, each of the gNB 200 and the UE 100 needs to update the HFN in response to transmission and reception of the PDCP data PDU, specifically, count up the HFN every time the PDCP sequence number makes one round.

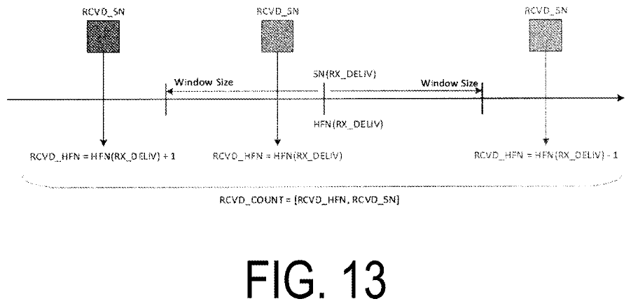

FIG. 13 is a diagram illustrating operations for identifying RCVD_COUNT that is a COUNT value of the PDCP data PDU received in the UE 100 (the receiving PDCP entity 101). Here, the PDCP SN included in the received PDCP data PDU is referred to as RCVD_SN.

First, when RCVD_SN<SN (RX_DELIV)−Window_Size, RCVD_HFN=HFN(RX_DELIV)+1. Here, RX_DELIV is a variable indicating the oldest of the PDCP SDUs which are to be received and have not yet been provided to an upper layer. The initial value of RX_DELIV is zero. In a PTM reception, the initial value of RX_DELIV may be set using the SN of the first received packet. Window_Size is a constant indicating the size of a reordering window.

Second, when RCVD_SN≥SN (RX_DELIV)+Window_Size, RCVD_HFN=HFN(RX_DELIV)−1.

Third, when neither of the above conditions is satisfied, RCVD_HFN=HFN(RX_DELIV).

Then, RCVD_COUNT=[RCVD_HFN, RCVD_SN] is set.

### Overview of PDCP Status Report

A general PDCP status report is now described. The UE 100 transmits a PDCP status report (Status Report) indicating a data reception status in the PDCP layer to the gNB 200. The gNB 200 can identify a missing PDCP packet (PDCP SDU), based on the PDCP status report from the UE 100 and retransmit the identified PDCP packet to the UE 100.

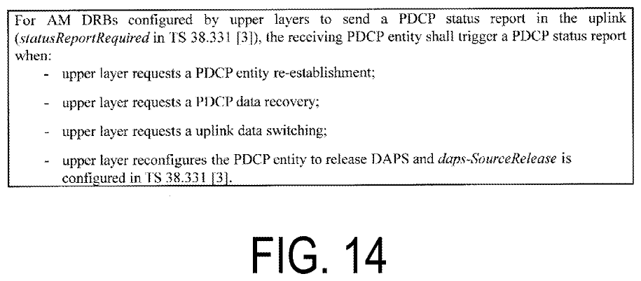

FIG. 14 is a diagram illustrating operations of the receiving PDCP entity 101 of the UE 100 related to the PDCP status report. Note that FIG. 14 is quoted from the 3GPP technical specifications “TS38.323” for the PDCP layer.

The receiving PDCP entity 101 of the UE 100 triggers transmission of the PDCP status report when any of the following conditions is met for an Acknowledged Mode (AM) Data Radio Bearer (DRB) configured by an upper layer (RRC layer) to transmit the PDCP status report:
The upper layer requests a PDCP entity re-establishment;
The upper layer requests a PDCP data recovery;
The upper layer requests an uplink data switching; or
The upper layer reconfigures the PDCP entity to release DAPS.

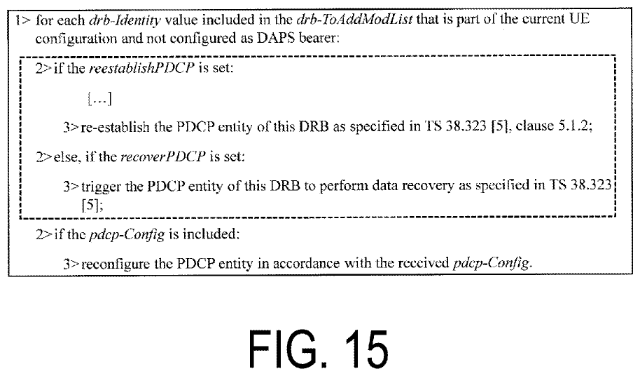

FIG. 15 is a diagram illustrating operations of the RRC entity 102 of the UE 100 related to the PDCP status reporting. Note that FIG. 15 is quoted from the 3GPP technical specifications “TS38.331” for the RRC layer.

The RRC entity 102 of the UE 100, for each DRB identity (drb-Identity) included in drb-ToAddModList that is part of the current UE configuration:
re-establishes the PDCP entity of that DRB when the PDCP re-establishment (reestablishPDCP) is set; or
triggers the PDCP entity of that DRB to perform data recovery when the PDCP recovery (recoverPDCP) is set.

In this way, according to the operations of the existing technical specifications for the DRB, the UE 100 triggers the transmission of the PDCP status report in response to receiving the indication, through the RRC signalling from the gNB 200, of the PDCP re-establishment or the PDCP recovery. Note that the existing technical specifications do not define whether to apply the PDCP status report for the MRB and how to trigger the PDCP status report when applying the PDCP status report for the MRB.

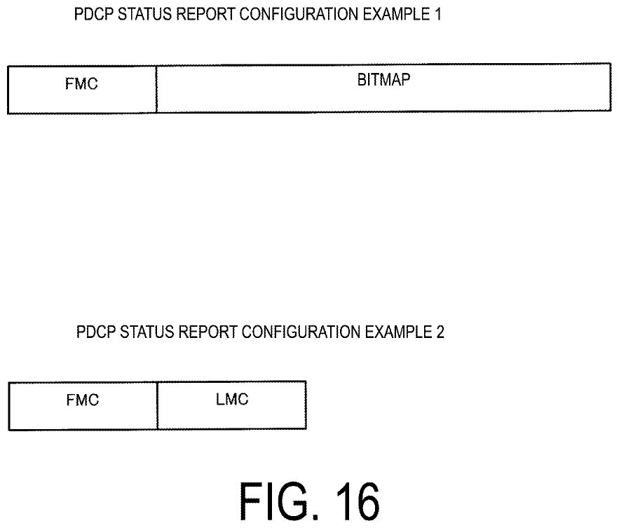

FIG. 16 is a diagram illustrating a configuration example of the PDCP status report. Note that a D/C field indicating that the PDU is a control PDU and a PDU type field indicating that the PDU is a PDCP status report may be provided at a head of a PDCP control PDU constituting the PDCP status report.

In a configuration example 1 illustrated in FIG. 16, the PDCP status report includes fields of a First missing COUNT (FMC) and a bitmap. The FMC field is set to a COUNT value of the first missing PDCP SDU in a reordering window, i.e., RX_DELIV. The bit map field is set to a bit associated with each PDCP PDU, specifically “1” when the PDCP PDU is correctly received, or “0” when the PDCP PDU is missed.

In a configuration example 2 illustrated in FIG. 16, the PDCP status report includes fields of an FMC and a Last missing COUNT (LMC). The LMC field is set to the sequence number (COUNT value) of the last packet of a missing packet group. The LMC field may be set to a COUNT value of the first successfully received packet (LMC+1, for example, First Successful COUNT: FSC). In the configuration example 1 described above, the bit length of the bitmap field may be long (for example, the bitmap for 200 packets has 200 bits). However, by providing the LMC field instead of the bitmap field, the bit length of the PDCP status report can be shortened.

### Operations According to First Embodiment

As described above, the RRC entity 202 of the gNB 200 may change the bearer type of the MRB through RRC signalling, specifically, an RRC Reconfiguration message, that the RRC entity 202 transmits to the RRC entity 102 in the UE 100. Here, a processing delay occurs from when the UE 100 receives the RRC reconfiguration message to when the RRC reconfiguration processing is completed. During this delay time, the MBS data cannot be received, and MBS data packets are problematically missed in the UE 100, that is, packet loss occurs.

As described above, the PDCP layer has the PDCP status report as a mechanism capable of compensating for packet loss. To be more specific, the UE 100 transmits to the gNB 200 a PDCP status report indicating a data reception status in the PDCP layer. The gNB 200 can identify a missing PDCP packet based on the PDCP status report from the UE 100 and retransmit the identified PDCP packet to the UE 100.

In the first embodiment, the UE 100 autonomously triggers the transmission of the PDCP status report, so that the packet loss caused by the bearer type change of the MRB can be compensated by the PDCP status report. Specifically, for the PDCP status report, a new transmission triggering condition related to MBS reception is introduced.

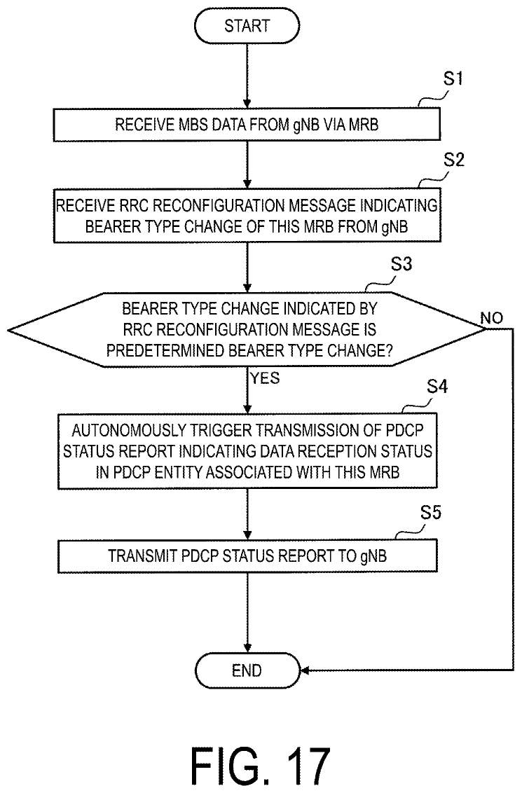

FIG. 17 is a diagram illustrating operations of the UE 100 according to the first embodiment.

In step S1, the UE 100 receives MBS data via the MRB from the gNB 200. As described above, the bearer type of the MRB includes three types of “PTM only”, “PTP only”, or “both PTM and PTP” (i.e., split MRB).

In step S2, the UE 100 receives an RRC Reconfiguration message indicating a bearer type change of the MRB from the gNB 200. The RRC reconfiguration message includes a configuration to perform a bearer type change of the established MRB. For example, the RRC reconfiguration message may include a bearer identifier of the MRB and bearer type information indicating a bearer type to which the MRB is to be changed.

In step S3, the UE 100 determines whether the bearer type change indicated by the RRC reconfiguration message received in step S2 is a to a predetermined bearer type change.

When the bearer type change is the predetermined bearer type change (step S3: YES), in step S4, the UE 100 autonomously triggers the transmission of a PDCP status report indicating a data reception status in the PDCP entity associated with the MRB (the receiving PDCP entity 101).

In step S5, the UE 100 transmits the PDCP status report to the gNB 200.

In this way, the UE 100 autonomously triggers the transmission of the PDCP status report when the predetermined bearer type change is indicated from the gNB 200. This allows the packet loss caused by the bearer type change of the MRB to be compensated by the PDCP status report.

Here, “autonomously triggering” refers to the UE 100 triggering the transmission of the PDCP status report without an explicit indication, from the gNB 200, of triggering the transmission of the PDCP status report. For example, the UE 100 triggers the transmission of the PDCP status report in response to the predetermined bearer type change without an indication of the PDCP re-establishment or the PDCP recovery through the RRC signalling from the gNB 200.

Although performing the PDCP re-establishment or the PDCP recovery for the purpose of triggering the transmission of the PDCP status report may be inefficient, the transmission of the PDCP status report can be triggered without the PDCP re-establishment or the PDCP recovery according to the first embodiment. The transmission of the PDCP status report may not be triggered for, for example, an MBS service in which packet loss is allowed, by limiting the bearer type change that triggers the transmission of the PDCP status report to the predetermined bearer type change.

Such an operation is applied to the bearer type change of the established MRB, and is not applied when a new MRB is established. That is, the UE 100 does not perform autonomous transmission triggering of the PDCP status report when establishing a new MRB.

### Examples of First Embodiment

Given the operations according to the first embodiment described above, first to third examples of the first embodiment are described.

### (1) First Example

In this example, the predetermined bearer type change is a change to a Point-To-Point (PTP) only MRB type or a change to a split MRB. That is, the UE 100 triggers transmission of a PDCP status report (only) upon a change to the PTP only or split MRB.

Here, the bearer type change to the PTP only or split MRB includes following four patterns:
1) from PTM only to PTP only;
2) from PTM only to split MRB;
3) from PTP only to split MRB; and
4) from split MRB to PTP only.

The PTM only MRB cannot transmit a PDCP status report even if attempting to transmit the report because no uplink path is present. The PTM only MRB is considered to be not required to be highly reliable as compared with the PTP only MRB and the split MRB. Therefore, in this example, the transmission of the PDCP status report is triggered (only) upon a change to the PTP only or split MRB.

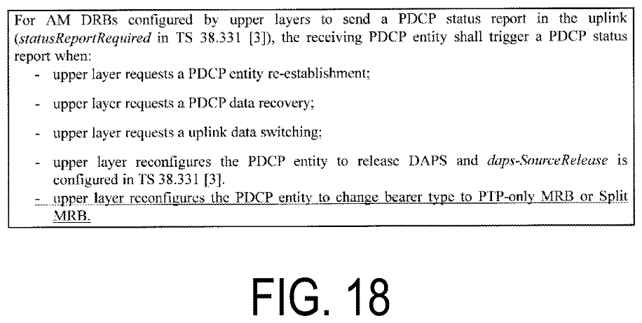

FIG. 18 is a diagram illustrating operations of the receiving PDCP entity 101 of the UE 100 according to this example. In FIG. 18, a portion different from those in FIG. 14 is underlined. However, “DRB” in FIG. 18 may be read as “MRB”.

The UE 100 is configured, in the PDCP entity of the MRB (the receiving PDCP entity 101), with statusReportRequired, and triggers a PDCP status report when the upper layer reconfigures the PDCP entity to change the bearer type to PTP-only MRB or split MRB.

### (2) Second Example

In this example, the predetermined bearer type change is a change to an Acknowledged Mode (AM) MRB type. That is, the UE 100 triggers transmission of a PDCP status report (only) upon a change to the AM MRB.

The PTM only MRB is considered to be handled as an Unacknowledged Mode (UM) MRB. The gNB 200 is considered to have a motivation to set the UE 100 to the PTM (-only) as much as possible because the PTM (particularly, PTM only) is more efficient in using radio resources than the PTP.

In this case, the gNB 200 is considered, for example, to use the bearer type change to set the PTM (-only) (i.e., UM MRB) when the radio state is good or set the PTP only or split MRB (i.e., AM MRB) when the radio state is poor. The radio condition can be determined based on, for example, an existing measurement report.

Here, for a service requiring a certain degree of high reliability, following methods for packet loss compensation upon bearer type change are present:
Change from the AM to the UM;
   Transmit packets ahead of the SN of the UM (PTM) in advance in the AM (PTP);
Change from the UM to the AM;
   Transmit later a packet lost in the UM (PTM), in the AM (PTP). Here, a PDCP status reporting is required.

Therefore, in this example, upon a change to the AM MRB, the UE 100 performs the autonomous transmission triggering of the PDCP status report. The change to the AM MRB (MRB reconfiguration) includes following two patterns.
1) from UM MRB to AM MRB;
2) from AM MRB to AM MRB; for example, from the split MRB to the PTP only MRB.

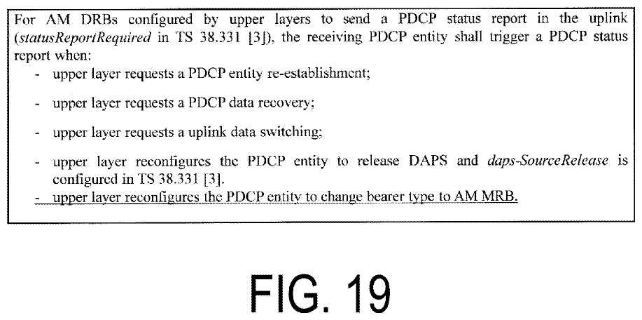

FIG. 19 is a diagram illustrating operations of the receiving PDCP entity 101 of the UE 100 according to this example. In FIG. 19, a portion different from those in FIG. 14 is underlined. However, “DRB” in FIG. 19 may be read as “MRB”.

The UE 100 is configured, in the PDCP entity of the MRB (the receiving PDCP entity 101), with statusReportRequired, and triggers a PDCP status report when the upper layer reconfigures the PDCP entity to change the bearer type to AM MRB.

### (3) Third Example

In this example, the predetermined bearer type change is a change from the PTM only MRB type to another MRB type. That is, the UE 100 triggers transmission of a PDCP status report (only) upon a change from the PTM only to other than PTM only.

In the split MRB, packet loss compensation can be performed by using the PTP leg, but when packet loss compensation is performed for the PTM only MRB, a bearer type change is necessarily required. Therefore, a PDCP status report is triggered (only) upon a change from the PTM only to other than the PTM only.

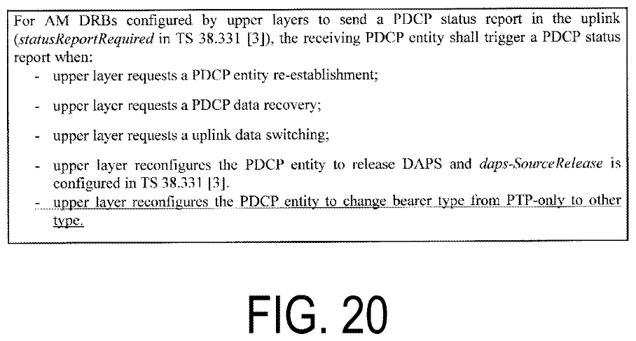

FIG. 20 is a diagram illustrating operations of the receiving PDCP entity 101 of the UE 100 according to this example. In FIG. 20, a portion different from those in FIG. 14 is underlined. However, “DRB” in FIG. 20 may be read as “MRB”.

The UE 100 is configured, in the PDCP entity of the MRB (the receiving PDCP entity 101), with statusReportRequired, and triggers a PDCP status report when the upper layer reconfigures the PDCP entity to change the bearer type from PTP-only to other type.

### Second Embodiment

A second embodiment is described mainly regarding differences from the first embodiment described above.

In the second embodiment, a scenario is mainly assumed in which the UE 100 performing MBS reception (PTM reception) in the RRC idle state or the RRC inactive state transitions to the RRC connected state by the random access procedure. In such a scenario, during the random access procedure, the UE 100 cannot perform the MBS reception, and MBS data packet loss may occur. In the second embodiment, such packet loss can be compensated for.

For example, the UE 100 autonomously triggers a transmission of a PDCP status report when transitioning to the RRC connected state. The RRC entity 102 of the UE 100 may notify the receiving PDCP entity 101 of the transition to the RRC connected state, and the receiving PDCP entity 101 may autonomously trigger the transmission of the PDCP status report in response to the notification. However, there may be a case where no packet loss occurs even if the random access procedure is performed. Therefore, the UE 100 may autonomously trigger the PDCP status report upon an occurrence of packet discard in the RLC. Specifically, the receiving PDCP entity 101 of the UE 100, when notified of the packet discard by the RLC layer, may autonomously trigger the PDCP status report.

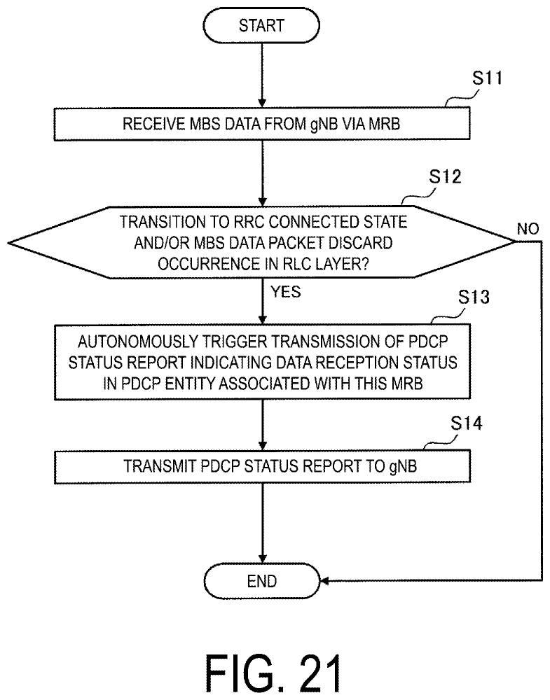

FIG. 21 is a diagram illustrating operations of the UE 100 according to the second embodiment.

In step S11, the UE 100 in the RRC idle state or the RRC inactive state receives MBS data via the MRB from the gNB 200.

In step S12, the UE 100 determines whether at least one of the conditions is satisfied, the transition from the RRC idle state or the RRC inactive state to the RRC connected state, and the discard of the MBS data packet occurring in the RLC layer.

When the at least one of the conditions is satisfied (step S12: YES), the UE 100, in step S13, autonomously triggers transmission of a PDCP status report indicating a data reception status in the PDCP entity associated with the MRB.

In step S14, the UE 100 transmits the PDCP status report to the gNB 200.

### Third Embodiment

A third embodiment is described mainly on differences from the first and second embodiments.

The third embodiment is the same as the first and second embodiments in that the gNB 200 indicates, to the UE 100, the bearer type change for the MRB, but the gNB 200 makes the UE 100 trigger the PDCP status report upon the indication. To be more specific, the gNB 200 includes a first information element (reestablishPDCP) in the RRC message (RRC reconfiguration message) indicating the bearer type change of the MRB. The first information element indicates re-establishment of a PDCP entity (receiving PDCP entity 101) associated with the MRB.

However, when indicating such RRC reestablishment, a header compression protocol in the PDCP entity (the receiving PDCP entity 101), specifically, an operation of Robust Header Compression (RoHC) is reset, and a RoHC context is also reset. The RoHC context includes a fixed value in the header and information for predicting a value in the header, and is information necessary for the UE 100 to restore the compressed header. When the RoHC context is also reset, a complete header that is not compressed needs to be transmitted and received after the bearer type change, thus an overhead problematically increases.

Therefore, in the third embodiment, when the gNB 200 includes the first information element (reestablishPDCP) in the RRC reconfiguration message indicating the bearer type change of the MRB, the gNB 200 includes a second information element (drb-ContinueROHC) in the RRC reconfiguration message. The second information element indicates maintaining the state of the header compression protocol (for example, RoHC context) in the PDCP entity (the receiving PDCP entity 101) of the UE 100. This can maintain the state of the header compression protocol (for example, RoHC context) in the PDCP entity (the receiving PDCP entity 101) of the UE 100 to make it possible to transmit and receive the compressed header even after the bearer type change.

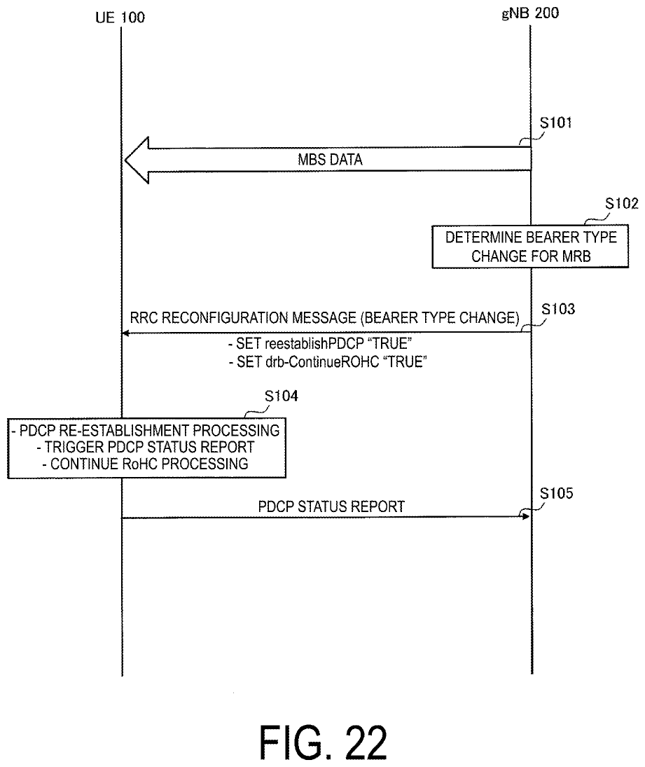

FIG. 22 is a diagram illustrating an operation of the mobile communication system 1 according to the third embodiment.

In step S101, the UE 100 receives the MBS data via the MRB from the gNB 200.

In step S102, the gNB 200 determines a bearer type change for the MRB. Specifically, the gNB 200 determines a change between three types, the PTP only, the PTM only, and the split MRB (PTP and PTM legs). For example, the gNB 200 makes the determination in step S102 according to a report of radio quality (measurement report) from the UE 100 and/or a radio resource status of the gNB 200.

In step S103, the gNB 200 transmits an RRC PDU reconfiguration message for bearer type change to the UE 100. The RRC reconfiguration message includes a configuration to perform a bearer type change of the established MRB. For example, the RRC reconfiguration message may include a bearer identifier of the MRB and bearer type information indicating a bearer type to which the MRB is to be changed. Here, the gNB 200 sets “reestablishPDCP ‘true’” and “drb-ContinueROHC ‘true’” in the RRC reconfiguration message in association with the MRB identifier.

In step S104, the UE 100 that receives the RRC reconfiguration message re-establishes the PDCP entity (the receiving PDCP entity 101) in response to “reestablishPDCP ‘true’” included in the RRC reconfiguration message, and triggers transmission of a PDCP status report in response to the re-establishment (see the PDCP operation in FIG. 14). Here, the UE 100 continues the RoHC processing according to “reestablishPDCP ‘true’” included in the RRC reconfiguration message (to be more specific, continues to use the RoHC context that has been used until immediately before and maintains the RoHC state).

In step S105, the UE 100 transmits the PDCP status report to the gNB 200. The gNB 200 receives the PDCP status report.

### OTHER EMBODIMENTS

The operation flows described above can be separately and independently implemented, and also be implemented in combination of two or more of the operation flows. For example, some steps of one operation flow may be added to another operation flow or some steps of one operation flow may be replaced with some steps of another operation flow.

In the embodiments and examples described above, an example in which the base station is an NR base station (i.e., a gNB) is described; however, the base station may be an LTE base station (i.e., an eNB) or a 6G base station. The base station may be a relay node such as an Integrated Access and Backhaul (IAB) node. The base station may be a DU of the IAB node. The user equipment may be a Mobile Termination (MT) of the IAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, System on a chip (SoC)).

Embodiments have been described above in detail with reference to the drawings, but specific configurations are not limited to those described above, and various design variation can be made without departing from the gist of the present disclosure.

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

### Supplementary Note

### 1. Introduction

In RAN2 #115e, the work item of the NR multicast and broadcast service (MBS) was achieved in the following agreement on the multicast service continuity.

In RRC signalling, one MRB can be configured with PTM only, PTP only, or both PTM and PTP. Either PTM, PTM+PTP, or PTP only can be changed by the RRC signalling.

In the RRC signalling, DL with only UM RLC configuration for PTM, DL and UL AM RLC configuration for PTP, and DL with only UM RLC configuration for PTP are supported. Supporting DL and UL UM RLC configurations for PTP requires further study.

Whether or not the PDCP SR is generated due to the bearer type change of the RRC signal and the generation method of the PDCP SR when the PDCP SR is generated will be further studied.

Inactivation/activation of PTM beyond RRC reconfiguration according to the above first agreement is not supported.

In the set of PTM PDCP state variables being configured, the SN part of the COUNT value of these variables is set according to the SN of the packet first received (by the UE) and optionally the HFN indicated by the gNB.

The PTM RLC entity of the MRB configuration is initialized and the values of RX_Next_Highest and RX_Next_Reassembly are set according to the SN of the first received packet including the SN.

With the MRB configuration, the 0RLC state variable of the PTP RLC receive window can be set to an initial value (0).

In this supplementary note, the remaining problems related to the multicast service continuity is discussed.

### 2. Discussion

### 2.1. PDCP Status Report Upon Bearer Type Change

RAN2 #115e agreed to the following open issues.

In the RRC signalling, DL with only UM RLC configuration for PTM, DL and UL AM RLC configuration for PTP, and DL with only UM RLC configuration for PTP are supported. Supporting DL and UL UM RLC configurations for PTP requires further study.

Whether or not the PDCP SR is generated due to the bearer type change of the RRC signal and the generation method of the PDCP SR when the PDCP SR is generated will be further studied.

According to current PDCP specifications, PDCP status report is triggered by RRC upon occurrence of the following events, mainly for AM DRBs (and possibly UM DRBs).

For AM DRB configured by an upper layer to transmit a PDCP status report in the uplink (statusReportRequired in TS38.331), the receiving PDCP entity needs to trigger the PDCP status report in the following cases.
The upper layer requests PDCP entity re-establishment.
The upper layer requests PDCP data recovery.
The upper layer requests uplink data switching.
The upper layer reconfigures the PDCP entity to release the DAPS, and daps-SourceRelease is configured according to TS 38.331.

For UM DRB configured by an upper layer to transmit a PDCP status report in the uplink (statusReportRequired in TS38.331), the receiving PDCP entity needs to trigger the PDCP status report in the following cases.

The upper layer requests uplink data switching.

In the MBS, the PTM-only MRB is configured with only RLC UM, whereas the PTP-only MRB and the PTP-leg of split MRB are configured with RLC UM or RLC AM. These are referred to as UM MRB and AM MRB, respectively.

According to the current RRC specifications, the performance requirement of the UE with respect to the processing delay of RRC reconfiguration is defined as the 10 ms. Therefore, the UE may miss the MBS transmission during the RRC reconfiguration for bearer type change, and the missing packets need to be compensated after the bearer type change. In this sense, the PDCP status reports should be supported at least to meet the higher reliability required by a particular MBS service.

It is also worth studying when a PDCP status report is needed. Since the AM MRB generally assumes a “high QoS” MBS service, reliability is obviously required also for the bearer type change. The bearer type change between AM MRBs includes the bearer type change from a UM MRB to an AM MRB.
Proposal 1: RAN2 should agree that PDCP status report is supported for lossless bearer type change at least between AM MRBs and from a UM MRB to an AM MRB.

In general, a UM MRB is considered not to require reliability, i.e., lossless, upon bearer type change. However, whether a UM MRB is used for a “high QoS” MBS service can actually be left to the implementation of the NW. The NW can efficiently operate the resources by using the PTM-only MRB for the UE in a good radio state and reconfiguring the PTP-only MRB (or the split MRB) when the radio state deteriorates to a certain level or less. Given that in the current specifications a UM DRB is allowed to trigger a PDCP status report in some cases, it is readily apparent that whether the NW needs a PDCP status report can be configured for the UM MRB. In this case, the PTP-only MRB and the PTP-leg of split MRB need to be configured with a DL/UL bi-directional UM, i.e. a DL RLC entity for MBS data reception and a UL RLC entity for PDCP status report transmission.
Proposal 2: RAN2 should agree that it is up to the NW implementation whether to use the PDCP status report upon bearer type change of the UM MRB. To this end, a specification is required for configuring the PTP with a DL/UL bi-directional RLC UM.

### 2.2. PTM PDCP/RLC State Variables

### 2.2.1. Initial Value

RAN2 #115e agreed to the following statements.

In the set of PTM PDCP state variables being configured, the SN part of the COUNT value of these variables is set according to the SN of the packet first received (by the UE) and optionally the HFN indicated by the gNB.

The PTM RLC entity of the MRB configuration is initialized and the values of RX_Next_Highest and RX_Next_Reassembly are set according to the SN of the first received packet including the SN.

The term “according to” in the two contracts intends the following three options.

Option 1: The initial value of each state variable is simply set to the SN of the first received packet.

Option 2: Rel-16 V2X solution is reused.

For PDCP “RX_NEXT”, “the initial value of the SN part of RX_NEXT is (x+1) modulo (2^{[sl-PDCP-SN-Size]}), where x is the SN of the first received PDCP data PDU”. For PDCP “RX_DELIV”, “the initial value of the SN part of RX_DELIV is (x−0.5×2^{[sl-PDCP-SN-Size-1]}) modulo (2^{[sl-PDCP-SN-Size]}), where x is the SN of the PDCP Data PDU first received”. RLC UM “RX_Next_Reassembly” is “initialized to the SN of the first received UMD PDU containing the SN”.

RLC UM “RX_Next_Highest” is “initialized to the SN of the first received UMD PDU containing the SN”.

Option 3: A new mechanism for RLC UM is introduced.

For the PDCP state variables, either Option 1 or 2 can be applied.

RLC UM “RX_Next_Reassembly” is “initialized to a value prior to “RX_Next_Highest”. RLC UM “RX_Next_Highest” is “initialized to the SN of the first received UMD PDU containing the SN” as in Option 2 above.

For the PDCP state variable, in Option 2, the next received packet, RX_NEXT, is set to ([the SN of the first received packet]+1). The packet not first delivered to an upper layer, RX_DELIV, is set to ([the SN of first received packet]−[¼ of the SN length]). This means that reordering can be performed even if an older packet is received after the first received packet. Therefore, Option 2 is considered to be more reliable than Option 1.
Proposal 3: RAN2 should agree, for the PDCP, that the initial value of RX_NEXT is ([the SN of the first received packet]+1) modulo (2[the PDCP SN length]), as in Rel-16 V2X.
Proposal 4: RAN2 should agree, for the PDCP, that the initial value of RX_DELIV is {[the SN of the first received packet]−2([the PDCP SN length]−2)} modulo (2[the PDCP SN length]), as in Rel-16 V2X.

For the RLC state variables, Options 1 and 2 are exactly the same. Options 2 and 3 are also the same in terms of RX_Next_Highest. Therefore, RAN2 may confirm that no other solutions are present for the initial value of RX_Next_Highest.
Proposal 5: RAN2 should agree to RLC UM that the initial value of RX_Next_Highest is the SN of the first received packet, as in Rel-16 V2X.

With respect to RX_Next_Reassembly, Options 2 and 3 are different. The advantages of Option 3 are similar to Option 2 for the PDCP state variables. That is, an older packet received after the first received packet can be prevented from being discarded. This problem is also pointed out to occur only when RLC segmentation is performed, but minimization of packet loss, if possible, is always good.
Proposal 6: RAN2 should discuss for RLC UM whether the initial value of RX_Next_Reassembly is the SN of the first received packet (same as in Rel-16 V2X) or the value prior to RX_Next_Highest.

### 2.2.2. HFN Provisioning

1) Whether SA3 uses the HFN for security, 2) whether PDCP status report is supported because COUNT has the HFN part, as described in RAN2 #115e, etc. The PDCP status report is already agreed to be supported for handover and will also be supported for the bearer type change as in chapter 2.1. Therefore, the HFN needs to be indicated by the gNB as agreed by RAN2.

Then, it should be discussed how the gNB provides the HFN to the UE. As a method of providing the HFN, the following options can be considered.
Alt. 1: RRC reconfiguration
Alt. 2: PDCP control PDU
Alt. 3: MCCH
Alt. 4: SIB
Alt. 5: Header of PDCP data PDU
Alt. 1 is considered simple because the gNB needs to configure the MRB for multicast to the UE by RRC reconfiguration, i.e. the HFN is configured together with the MRB. However, since the RRC reconfiguration is dedicated signalling for a specific UE and is basically used only in the first delivery mode (Delivery mode 1: DM1), thus, the processing is a little heavier than Alt. 2, which is disadvantageous. A certain timing gap is between the reception of the RRC reconfiguration and the first received packet, which may cause HFN un-synchronization. Further, additional information may be needed to indicate to which MRB the HFN applies.
Alt. 2 is considered to be a lighter and more efficient signalling because the gNB can indicate the HFN on the PTM. Since the PDCP entity is associated with the MRB, the additional information of mapping between the HFN to the MRB is not required. That is, the PDCP entity that receives this PDCP control PDU may apply the HFN as an initial value. This is generally used in the first delivery mode and the second delivery mode (Delivery mode 2: DM2). The timing gap between the PDCP control PDU and the first received packet may be minimized because the same PDCP entity processes these PDCP PDUs. However, the PDCP control PDU may not be security-protected.
Alt. 3 is another possibility, but the MCCH is only applicable to the second delivery mode, and it may not be preferable to oblige the UE receiving the first delivery mode to acquire the MCCH as the additional burden. A certain timing gap may be between the reception of the MCCH and the first received packet. Furthermore, as in Alt. 1, the additional information of mapping between the HFN to the MRB may be required, and thus it is not preferable to oblige acquisition of the MCCH.
Alt. 4 is considered as a normal provisioning method. Although the SIB basically applies to both the first delivery mode 1 and the second delivery mode, it is still unclear whether a UE connected for multicast reception is obligated to monitor the SIB. The concern is that the SIB is not security-protected as in Alt. 2, the additional information of mapping between the HFN and the MRB occurs as in Alt. 1, and a certain timing gap occurs between the SIB reception and the first received packet. When applying on-demand SI, the UE needs to transmit an on-demand SI request message before acquiring the SIB, which may cause a delay of HFN initialization.
Alt. 5 shows advantages as in Alt. 2. That is, deliver with PTM is possible and no additional information is required, which is a common solution for the first delivery mode and the second delivery mode. In Alt. 5, the first received packet carries the HFN together, thus the most important advantage is theoretically the timing gap. However, assuming that the header of the first received packet includes the HFN, it is questionable how the gNB knows the first received packet of the UE given that the packet is beginning to be transmitted to other UEs via PTM. Otherwise, the gNB always needs to include the HFN in each data packet. The concern is that the PDCP header is not security-protected as in Alt. 2. The HFN provisioning is considered as C-plane signalling like other alternatives including Alt. 2, and thus, is a bit strange from a concept/principle point of view. On the other hand, Alt. 5 uses U-plane data.
When viewed from another angle, it can be seen that the HFN provisioning method is different between the first delivery mode (DM1) and the second delivery mode (DM2). In general, the DM1 (or multicast) is more secure than the DM2 (or broadcast). This is because the configuration is provided through dedicated signalling (and a session join procedure is available in NAS). In this sense, the HFN also needs to be securely provided in the DM1. In this case, Alt. 1 is the simplest solution, but is not suitable for realizing commonality between the DM1 and the DM2. Alt. 2 is assumed to be able to ensure a certain degree of security compared to Alt. 3, Alt. 4, and Alt. 5 when the PDCP control PDU is transmitted with the C-RNTI. On the other hand, the DM2 should not oblige the UE to transition to CONNECTED but is only for the purpose of acquiring the HFN. To support the DM2, the HFN is periodically provided in a broadcast manner (i.e., using G-RNTI, MCCH-RNTI, or SI-RNTI).

As noted above (as also summarized in a table below), it can be said that providing the HFN via the PDCP control PDU (i.e., Alt. 2) is slightly preferred, in which performance and security are balanced and which is a common solution for both delivery modes (i.e., the DM1 and the DM2).
Proposal 7: RAN2 should agree that the initial value of the HFN is provided via the PDCP control PDU.
Proposal 8: When Proposal 7 is agreeable, RAN2 should further agree that the PDCP control PDU (for HFN provisioning) can be transmitted together with G-RNTI and C-RNTI.

TABLE 1

| | | Alt. 2 | | | Alt. 5 |
|---|---|---|---|---|---|
| | Alt. 1 | PDCP | | | Header of |
| | RRC | control | Alt. 3 | Alt. 4 | PDCP data |
| | reconfiguration | PDU | MCCH | SIB | PDU |
| Point-to- | N/A | Applicable | Applicable | Applicable | Applicable |
| multipoint | | (With | (MCCH- | (SI-RNTI) | (G-RNTI) |
| provisioning | | G-RNTI) | RNTI) | | |
| | | Applicable | | | |
| | | C-(With | | | |
| | | RNTI) | | | |
| Timing gap | Large | Very small | Large | Large | No difference |
| between HFN | | | | | |
| provisioning | | | | | |
| and first | | | | | |
| received data | | | | | |
| Overhead | Middle | Small | Middle | Middle | Large (when |
| | | | | | HFN is |
| | | | | | included in all |
| | | | | | data) |
| | | | | | Small (when |
| | | | | | only first |
| | | | | | received data |
| | | | | | includes HFN) |
| Mapping | Required | Not required | Required | Required | Not required |
| information | | | | | |
| between HFN | | | | | |
| and MRB | | | | | |
| Security | High | Low (when | Low | Low | Low |
| | | G-RNTI is | | | |
| | | used) | | | |
| | | Middle | | | |
| | | (when C- | | | |
| | | RNTI is | | | |
| | | used) | | | |
| UE RRC state | Only during | All states | All states | All states | All states |
| | connection | | | | |
| Common point | Low | High | Low | High | High |
| between DM1 | | | | | |
| and DM2 | | | | | |

### 2.2.3. Data Reception Before HFN Initialization

The UE may receive data before receiving the HFN. This is because the reception timings of the HFN and the first received packet may differ from each other due to out-of-order delivery (e.g. retransmission in bad radio conditions and/or retransmission during handover, etc.). And/or the timings differ depending on which option in section 2.2.2 is selected. Furthermore, since the PTM transmission already starts to be transmitted to another UE, the UE can receive data as soon as the MRB is set.
Observation 1: The UE may receive MBS data via PTM before the HFN initialization.

In the current PDCP specifications, RX_NEXT and RX_DELIV are (re) set to the initial values when RRC requests PDCP entity establishment, PDCP entity re-establishment, or PDCP entity suspension. Naturally, the COUNT value is initialized before the data reception. Thus, from a PDCP perspective, the data may not be received even though the lower layers are ready for data reception. That is, even when the RLC layer transmits the RLC SDU (PDCP PDU) to the PDCP layer, the data may not be received. Even when the PDCP accepts these PDCP PDUs, these PDCP PDUs are to be discarded due to the failure in integrity verification because the HFN is still aoristic.
Observation 2: Before the initialization of the HFN, according to current specifications, PDCP PDUs from the lower layers may not be accepted or may be discarded in the PDCP layer.

Thus, all of (some) extensions of the initialization of the state variable of the SN described in section 2.2.1 and minimizing packet loss as described in section 2.2.2 are aimed at. One simple way is for the PDCP to temporarily buffer these PDUs before the PDCP processing and start processing these PDUs after the initialization of the HFN.

Proposal 9: RAN2 should discuss how the UE processes the received data packet before the initialization of the HFN.

### 2.2.4. Request for HFN Provisioning

Another possible issue is whether the UE is allowed to query the gNB for the current HFN. Especially for PTM-only MRB, the HFN may be un-synchronized when the UE fails to receive packets for a certain time period, e.g. due to a coverage hole or interference. Another case is that when the HFN is provided only when an MBS session is activated (as briefly described in section 2.2.2), the HFN is required when the UE later joins an already activated MBS session.

Therefore, it is convenient to allow the UE to request the gNB to provide the current HFN when the UE is aware of the need for HFN provisioning. For example, how to transmit the request via RRC signalling or a PDCP control PDU needs further study. Under the same condition, the UE may not receive the next packet that is outside the receive window. In this case, the UE may reset all state variables to initial values.
Proposal 10: RAN2 should discuss whether the UE is allowed to request the gNB to provide the current HFN of the MBS session.
Proposal 11: RAN2 should discuss whether the state variable can be reset WHEN the UE fails to receive MBS session for a certain time period.

### 2.3. Lossless Mobility Operation

“RAN2 aims to support lossless handover of MBS-MBS mobility for a service requiring this (at least PTP-PTP although details of scenarios are undetermined)” and “PDCP status report may be supported from the UE”. These agreements mean a mechanism significantly similar to existing handover for unicast, when the MRB is configured with PTP only.
Observation 3: To support lossless handover, the existing handover mechanism for unicast cam be reused for MRB configured with only PTP.

In view of this, a study needs to be carried out on a case of handover including PTM (-leg), that is, the MRB configured with PTM only and the split MRB including the PTP leg and the PTM leg.

The split MRB can be regarded as the PTP-only MRB when the PTM leg is not used. Thus, the lossless handover can be easily supported based on existing unicast handover. In view of this, a basic procedure of the split MRB is considered as follows.
Step 1: The PTP leg of split MRB is used in the source cell as necessary due to lossless dynamic switch.
Step 2: The UE executes PTP-PTP handover (or as in unicast handover) and lossless handover.
Step 3: The PTM leg of split MRB is used in the target cell as necessary due to lossless dynamic switch.

At this time, the lossless dynamic switch ensured by the NW implementation plays an important role.
Observation 4: The lossless dynamic PTM/PTP switch is crucial for the lossless handover of the split MRB.

Regarding the PTM-only MRB, a significantly similar procedure as below can be applied.
Step 1: The PTM MRB is reconfigured to the PTP MRB (or the split MRB) in the source cell due to lossless bearer type change.
Step 2: The UE executes lossless handover as PTP-PTP handover (or as unicast handover).
Step 3: The PTP-only MRB (or the split MRB) is reconfigured to the PTM-only MRB in the target cell as necessary due to lossless bearer type change.

In this case, the lossless bearer type change described in chapter 2.1 is also important for the lossless handover.
Observation 5: The lossless bearer type change is crucial for the lossless handover of the PTM-only MRB.

From the above, the points of the basic procedures of the lossless handover are that whether the PTP leg is used or the PTM-only MRB is reconfigured (=step 1), and no enhancement is made where execution of handover is the same as existing unicast handover.
Proposal 12: RAN2 should agree that the basic lossless handover of the MRB always needs to include a PTP (-leg). That is, the PTP leg of split MRB is used or the PTM-only MRB is reconfigured to the PTP-only MRB (or the split MRB), and thereafter the handover is performed.
Proposal 13: RAN2 should agree that execution of the handover of the MRB is the same as that of unicast, that is, enhancement for basic lossless handover is not necessary.

Next, the most interesting advanced procedure is direct PTM-PTM handover. That is, the UE that receives the MBS via PTM (-leg) executes lossless handover. Signalling overhead and complexity in the basic handover procedure described above can be reduced. That is, steps 1 and 3 can be skipped. Furthermore, such a direct PTM-PTM lossless handover may be expected especially in a split MRB configured with PTP leg. That is, it is used for services that require higher reliability. However, the midpoint of Rel17 is already past, and WID only describes “support of basic mobility provided with service continuity is specified”. Thus, advanced lossless handover needs to be postponed until future releases.
Observation 6: Although advanced lossless handover of the UE that receives an MBS service via PTM (-leg), that is, “direct PTM-PTM handover”, may be effective for a specific service, this may need to be postponed until future releases in consideration of the remaining time of the Rel-17 time frame.

### 2.4. Multicast MBS Interest Indication

RAN2 assumes that MBS Interest Indication is supported in broadcast sessions but is not supported in multicast sessions. RAN2 #115e agreed to the basic content of the MBS Interest Indication as follows.

For CONNECTED

The UE reports the following MBS Interest information (as LTE SC-PTM).

### MBS Frequency List

### Priority Between Reception of all Listed MBMS Frequencies and Reception of any Unicast Bearers TMGI List

When reporting of MBS frequencies is allowed, the MBS frequencies reported by the UE are sorted in descending order of interest in a manner the same as and/or similar to LTE SC-PTM.

For a multicast session, it is generally understood that the core network informs the gNB of the interest of the UE because the multicast session has session join procedure in an upper layer. This applies to the MBS services of interest of the UE. The gNB may know the MBS frequency and the cell providing the MBS service of interest of the UE. However, the priority between MBS reception and unicast, which is purely AS-related information, may not be provided by the core network.
Observation 7: In a multicast session, the core network provides the gNB with the MBS service that is of interest to the UE, and the gNB may know the MBS frequency/cell. However, the core network and the gNB may not know the AS priority of the UE between MBS and unicast.

Priority information, in a manner the same as and/or similar to LTE eMBMS, is also useful for the gNB, such as scheduling and handover determinations, and may also be relevant to the service continuity. Therefore, the UE needs to inform the gNB of the priority information also for multicast sessions. In this sense, RAN2 should agree that MBS Interest Indication should also be supported for multicast service/delivery mode 1.
Proposal 14: RAN2 should agree that the MBS Interest Indication is also supported for multicast session/delivery mode 1, at least for the UE to inform the gNB of the priorities of MBS reception and unicast.

### REFERENCE SIGNS

1: Mobile communication system
10: RAN
20: CN
100: UE
101: Receiving PDCP entity
110: Receiver
120: Transmitter
130: Controller
200: gNB
201: Transmitting PDCP entity
210: Transmitter
220: Receiver
230: Controller
240: Backhaul communicator

1. A communication method in a mobile communication system configured to provide a multicast/broadcast service (MBS), the communication method comprising:
receiving, at a user equipment, MBS data from a network node via a multicast radio bearer (MRB);
receiving, at the user equipment from the network node, a radio resource control (RRC) reconfiguration message indicating a bearer type change of the MRB;
triggering, at the user equipment, transmission of a packet data convergence protocol (PDCP) status report indicating a data reception status in a PDCP entity associated with the MRB in response to the bearer type change indicated by the RRC reconfiguration message being a change to an Acknowledged Mode (AM) MRB type; and
transmitting the PDCP status report to the network node.

2. The communication method according to claim 1, comprising:
autonomously triggering, at the user equipment, transmission of a PDCP status report indicating a data reception status in a PDCP entity associated with the MRB in response to transition from an RRC idle state or an RRC inactive state to an RRC connected state and/or occurrence of discard of an MBS data packet in an RLC layer.

3. The communication method according to claim 1, comprising:
transmitting, from the network node to the user equipment, an RRC reconfiguration message that is a message indicating a bearer type change of the MRB, the RRC reconfiguration message comprising a first information element indicating re-establishment of a PDCP entity associated with the MRB; and
receiving, at the network node, a PDCP status report transmitted from the user equipment based on the first information element,
wherein the transmitting the RRC reconfiguration message comprises transmitting the RRC reconfiguration message further comprising a second information element indicating maintaining a state of a header compression protocol in the PDCP entity when the RRC reconfiguration message comprises the first information element.

4. A user equipment used in a mobile communication system configured to provide a multicast and broadcast service (MBS), the user equipment comprising:
a receiver configured to receive MBS data from a network node via a multicast radio bearer (MRB) and receive, from the network node, a radio resource control (RRC) reconfiguration message indicating a bearer type change of the MRB;
a controller configured to trigger transmission of a PDCP status report indicating a data reception status in a PDCP entity associated with the MRB in response to the bearer type change indicated by the RRC reconfiguration message being a change to an Acknowledged Mode (AM) MRB type; and
a transmitter configured to transmit the PDCP status report to the network node.

5. A processor for a user equipment used in a mobile communication system configured to provide a multicast and broadcast service (MBS), the processor comprising:
a receiver circuitry configured to receive MBS data from a network node via a multicast radio bearer (MRB) and receive, from the network node, a radio resource control (RRC) reconfiguration message indicating a bearer type change of the MRB;
a controller circuitry configured to trigger transmission of a PDCP status report indicating a data reception status in a PDCP entity associated with the MRB in response to the bearer type change indicated by the RRC reconfiguration message being a change to an Acknowledged Mode (AM) MRB type; and
a transmitter circuitry configured to transmit the PDCP status report to the network node.

6. A non-transitory computer readable medium that stores computer program comprising instructions that, when the computer program is executed by a user equipment, cause the user equipment to carry out the communication method according to claim 1.

7. A mobile communication system comprising: the user equipment according to claim 4; and a network node.
